(19) United States
(12) Patent Application Publication
(10) Pub. No.: US 2026/0334441 A1
(43) Pub. Date: Oct. 29, 2026

(54) COATING MATERIAL FOR COATING BASE MATERIAL OF FISHING MEMBER OR LIKE AND METHOD FOR FORMING SAME

(71) Applicant: GLOBERIDE, Inc., Higashikurume-shi, Tokyo (JP)

(72) Inventor: Naohiro SAKATA, Higashikurume-shi (JP)

(73) Assignee: GLOBERIDE, Inc., Higashikurume-shi, Tokyo (JP)

(21) Appl. No.: 19/117,742

(22) PCT Filed: Jul. 27, 2023
(86) PCT No.: PCT/JP2023/027541

§ 371 Date: Apr. 2, 2025

(30) Foreign Application Priority Data
Dec. 23, 2022 (JP) 2022-207306

(51) Int. Cl. A01K 87/00; A01K 89/00

(52) U.S. Cl. CPC A01K 87/00; A01K 89/00

(57) ABSTRACT

A coating material having a stable metallic appearance with high brightness and few defects and including a metal layer having an indium particle structure, a fishing reel or a fishing rod having the coating material formed thereon, and a method for forming the coating material. A coating material is a coating material directly or indirectly provided on a surface of a base material of a fishing member and including a metal layer having a large number of indium particle structures containing a large number of indium flakes, in which particle size of each of the indium flakes is 1 μm or less at a cumulative median value of 50%, and a particle size of the indium particle structure is in a range of 40 μm to 300 μm.

### TECHNICAL FIELD

### Cross Reference

The present application claims priority based on Japanese Patent Application No. 2022-207306 (filed on Dec. 23, 2022), the contents of which are incorporated herein by reference in their entirety.

The present invention relates to a coating material for coating a base material of a fishing member or the like and a method for forming the coating material. The present invention also relates to a fishing reel or a fishing rod having such a coating material. The present invention can also be applied to sports goods such as a golf club shaft and a tennis racket, and a method for forming a coating material on the sports goods.

### BACKGROUND ART

Conventionally, it is known to use indium vapor deposition for improving appearance quality.

As such a surface decoration structure, for example, Patent Literature 1 discloses a grill cover structure disposed in a front end opening portion of a vehicle and attached to a radiator grille formed in a lattice shape by bars, in which a black layer is formed on a part of a back surface side of a grill cover front surface portion formed of a transparent flat plate base material, a grill color layer having substantially the same color as the bars of the radiator grille is provided thereon, the grill color layer is formed to have a thickness with a rear surface side as a smooth surface, and the grill cover structure is formed by indium vapor deposition.

### CITATION LIST

### Patent Literature

Patent Literature 1: JP 2000-344032 A

### SUMMARY OF INVENTION

### Technical Problem

However, the method according to Patent Literature 1 has a problem that it is difficult to form a coating material having a stable appearance (metal color tone) with high brightness and few defects on a fishing member.

An object of the present invention is to provide a coating material having a stable metallic appearance with high brightness and few defects and comprising a metal layer having an indium particle structure, a fishing reel or a fishing rod having the coating material formed thereon, and a method for forming the coating material. Other objects of the present invention will become apparent upon reference to the entirety of the present specification.

### Solution to Problem

A coating material according to an embodiment of the present invention is a coating material directly or indirectly provided on a surface of a base material of a fishing member and comprising a metal layer having a large number of indium particle structures containing a large number of indium flakes, in which particle size of each of the indium flakes is 1 μm or less at a cumulative median value of 50%, and a particle size of the indium particle structure is in a range of 40 μm to 300 μm.

In a coating material according to an embodiment of the present invention, a ratio of the indium particle structure per unit area of a surface of the coating material is 25% or more, more preferably 50% or more, and less than 100%, more preferably 90% or less.

In a coating material according to an embodiment of the present invention, a height of the indium particle structure is in a range of 0.1 μm to 10 μm.

In a coating material according to an embodiment of the present invention, a lower coating layer is formed between the base material and the metal layer.

In a coating material according to an embodiment of the present invention, an upper coating layer is formed on a surface of the metal layer.

A coating method for forming a coating material according to an embodiment of the present invention is a coating method comprising: a step of dispersing a large number of indium flakes in a solvent and spraying the dispersion by spray radiation; and a step of drying the solvent, these steps being repeated a plurality of times to form a coating material, in which a particle size of each of the indium flakes is 1 μm or less at a cumulative median value of 50%, and a particle size of the indium particle structure is in a range of 40 μm to 300 μm.

In the coating material according to an embodiment of the present invention, the solvent is any one of a ketone-based solvent, an ether-based solvent, and an ester-based solvent, or a combination of any two or more of these solvents.

A fishing reel according to an embodiment of the present invention comprises a reel body and any one of the above coating materials formed on at least a part of a surface of the reel body.

A fishing rod according to an embodiment of the present invention comprises a rod body and any one of the above coating materials formed on at least a part of a surface of the rod body.

### Advantageous Effects of Invention

According to each of the above embodiments of the present invention, it is possible to provide a coating material having a stable metallic appearance with high brightness and few defects and comprising a metal layer having an indium particle structure, a fishing reel or a fishing rod having the coating material formed thereon, and a method for forming the coating material.

### BRIEF DESCRIPTION OF DRAWINGS

FIG. 1 is a view schematically illustrating a coating material according to an embodiment of the present invention.

FIG. 2 is a view schematically illustrating a coating material according to an embodiment of the present invention.

FIG. 3 is a view schematically illustrating a coating material according to an embodiment of the present invention.

### DESCRIPTION OF EMBODIMENTS

Hereinafter, embodiments of the present invention will be specifically described with reference to the attached drawings. Components that are common in a plurality of drawings are denoted by the same reference signs throughout the plurality of drawings. It should be noted that each drawing is not necessarily drawn to an accurate scale for convenience of description.

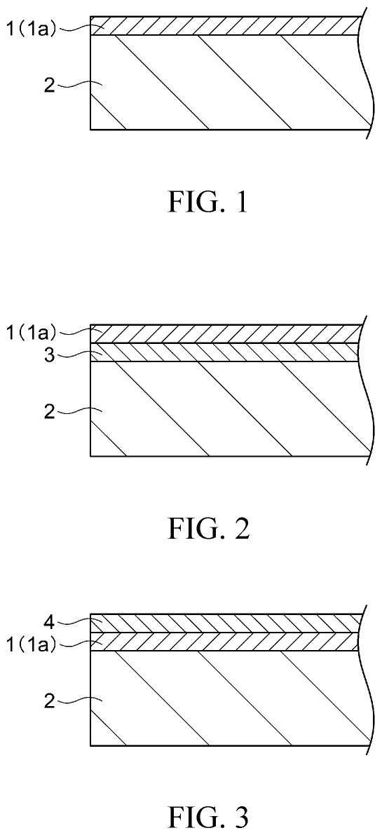

A coating material according to an embodiment of the present invention will be described with reference to FIG. 1. As illustrated in FIG. 1, a coating material 1 according to an embodiment of the present invention is the coating material 1 directly or indirectly provided on a surface of a base material 2 of a fishing member and comprising a metal layer 1a having a large number of indium particle structures containing a large number of indium flakes, in which a particle size of each of the indium flakes is 1 μm or less at a cumulative median value of 50%, and a particle size of the indium particle structure is in a range of 40 μm to 300 μm. Here, the fishing member refers to a fishing reel, a fishing rod, a reel seat, a lure, or a grip. In addition, the indium flake refers to, for example, a vapor deposited indium particle obtained by forming a metal layer containing indium on a peelable base material by vacuum vapor deposition and peeling, pulverizing, and dispersing the metal layer, and the indium particle structure refers to an aggregate of a large number (usually, 10,000 to 10 billion particles) of indium flakes. in addition, the coating material can also be rephrased as a coating film or a coating layer comprising the metal layer.

According to a coating material according to an embodiment of the present invention, it is possible to provide a coating material having a stable metallic appearance with high brightness and few defects and comprising a metal layer having an indium particle structure. More specifically, it is possible to form a stable metallic coating film structure with high brightness and few defects.

In a coating material according to an embodiment of the present invention, a ratio of the indium particle structure per unit area of a surface of the coating material is 25% or more, more preferably 50% or more, and less than 100%, more preferably 90% or less. In this way, a high brightness appearance can be formed.

In a coating material according to an embodiment of the present invention, a height of the indium particle structure is in a range of 0.1 μm to 10 μm. In this way, it is possible to form a favorable appearance without fogging.

Next, as illustrated in FIG. 2, in the coating material 1 according to an embodiment of the present invention, a lower coating layer 3 is formed between the base material 2 and the metal layer 1a. In this way, a high brightness appearance with high smoothness can be formed.

Next, as illustrated in FIG. 3, in the coating material 1 according to an embodiment of the present invention, an upper coating layer 4 is formed on a surface of the metal layer 1a. In this way, the metal layer can be fixed.

A coating method for forming a coating material according to an embodiment of the present invention is a coating method comprising: a step of dispersing a large number of indium flakes in a solvent and spraying the dispersion by spray radiation; and a step of drying the solvent, these steps being repeated a plurality of times to form a coating material, in which a particle size of each of the indium flakes is 1 μm or less at a cumulative median value of 50%, and a particle size of the indium particle structure is in a range of 40 μm to 300 μm.

According to a method for forming a coating material according to an embodiment of the present invention, it is possible to provide a coating material having a stable metallic appearance with high brightness and few defects and comprising a metal layer having an indium particle structure.

The method for forming a coating material according to an embodiment of the present invention will be described in more detail. First, a fishing member on which a coating material is to be formed is prepared (step 1). Then, a lower coating is applied to a material (base material) of the fishing member as necessary to form a smooth layer (lower coating layer) (step 1.2). When smoothness of a surface of the material (base material) is high, such a lower coating layer does not have to be necessarily formed on the material (base portion).

Next, a large number of indium flakes are dispersed in a solvent and applied to the material (base material) using spray radiation (for example, a spray gun) (step 2). At this time, after the atomized indium particles land on the material (base material), an indium particle structure is formed, and control is performed such that a particle size of the indium particle structure (state in which the solvent is evaporated) spreads in a range of 40 μm or more and 300 μm or less, whereby overlapping of the indium particle structures after landing can be suppressed.

Here, when the spread of the indium particle structure after landing is less than 40 μm, the solvent is rapidly volatilized. Therefore, the indium flakes cannot sufficiently spread, and as a result, gather and become white. On the other hand, when the particle size after formation of the indium particle structure (state in which the solvent is evaporated) is larger than 300 μm, since the spread of the indium particle structure after landing is large, adjacent indium particle structures are combined to form a large island portion. Since the size of the island portion is a size that can be visually confirmed, a uniform mirror surface appearance cannot be obtained. In addition, since the solvent is slowly volatilized, it is not suitable for recoating. Here, the landing refers to, for example, in a case of spray radiation, that the atomized indium flake-containing solvent reaches the base material (the same applies throughout the present specification). In addition, for example, for coating using a spray gun, the spread of the indium particle structure can be controlled after landing by adjusting a pattern pressure, an atomization pressure, a discharge amount, a gun distance, a gun moving speed, and the number of times of coating. Next, the applied solvent is dried (step 3). This process is repeated a plurality of times as necessary (recoating is performed) to achieve a more uniform finish. In addition, as the solvent, any one of a ketone-based solvent, an ether-based solvent, and an ester-based solvent, or a combination of any two or more of these solvents can be used

Next, an influence on an appearance of the indium particle structure formed by landing of the indium particles due to a difference in particle size after solvent evaporation (state in which the solvent is evaporated) will be described. First, it has been found that in a case where the particle size of the indium particle structure formed by landing of the indium particles after solvent evaporation (state in which the solvent is evaporated) is 20 μm to less than 120 μm and the thickness (height) of the indium particle structure is more than 10 μm, when the indium particle structure is observed with a microscope at a magnification of 200 times, as presented in Table 1, since the coating atomization size at the time of coating is small, the indium particle structure is dried immediately after landing, the indium particle structure does not sufficiently spread, the indium flakes gather, a thick portion is partially whitened and appears to be entirely cloudy, and the indium particle structure does not have a favorable appearance. Note that it has been also found that in a case where the particle size of the indium particle structure is 20 μm to less than 120 μm and the thickness (height) of the indium particle structure is less than 0.1 μm, although the indium particle structure is not whitened because of the too small thickness, the indium particle structure has no gloss and is dark, and thus does not have a metal appearance.

[Table 1]

On the other hand, it has been found that in a case where the particle size of the indium particle structure formed by landing of the indium particles after solvent evaporation (state in which the solvent is evaporated) is in a range of 40 μm to 300 μm (for example, 50 μm to 260 μm) and the thickness (height) of the indium particle structure is in a range of 0.1 μm to 10 μm, when the indium particle structure is observed with a microscope at a magnification of 200 times, as presented in Table 2, the coating atomization size at the time of coating is appropriate, and overlapping of the indium particle structures after landing can be suppressed, thereby providing a favorable appearance. In particular, it has also been found that a stable metal tone is exhibited at the time of recoating because the solvent is dried in about 10 seconds after formation of the indium particle structure.

Next, it has been found that in a case where the particle size of the indium particle structure formed by landing of the indium particles after solvent evaporation (state in which the solvent is evaporated) is in a range larger than 300 μm (for example, 330 μm or more), when the indium particle structure is observed with a microscope at a magnification of 200 times, as presented in Table 3, since the spread of the indium particle structure after landing is large (the coating atomization size at the time of coating is large), the indium particle structures after landing overlap in a process of spreading, and is divided into a large island portion and a large sea portion, therefore the indium particle structure looks like a sea-island pattern and appears to be uneven in color, and a uniform mirror surface appearance cannot be obtained. In addition, it has been found that since it takes one minute or more to dry the solvent, recoating is hindered after drying.

### [Table 3]

As described above, it has been found that in a case where the particle size of the indium particle structure formed by landing of the indium particles after solvent evaporation (state in which the solvent is evaporated) is in a range of 40 μm to 300 μm and the thickness (height) of the indium particle structure is in a range of 0.1 μm to 10 μm, it is possible to provide a coating material having a stable metallic appearance with high brightness and few defects and comprising a metal layer having an indium particle structure.

Although not illustrated, a fishing reel according to an embodiment of the present invention comprises a reel body and any one of the above coating materials formed on at least a part of a surface of the reel body. In this way, it is possible to provide a fishing reel on which a coating material having a stable metallic appearance with high brightness and few defects and comprising a metal layer having an indium particle structure is formed.

In addition, similarly, although not illustrated, a fishing rod according to an embodiment of the present invention comprises a rod body and any one of the above coating materials formed on at least a part of a surface of the rod body. In this way, it is possible to provide a fishing rod on which a coating material having a stable metallic appearance with high brightness and few defects and comprising a metal layer having an indium particle structure is formed.

The present invention can also be applied to sports goods such as a golf club shaft and a tennis racket, and a method for forming a coating material on the sports goods.

Dimensions, a material, and disposition of each component described in the present specification are not limited to dimensions, a material, and disposition that have been explicitly described in the embodiments, and variations can be made to these respective components in such a way that these respective components have arbitrary dimensions, material, and disposition that can be included in the scope of the present invention. In addition, components not explicitly described in the present specification can also be added to the described embodiments, or some of the components described in the embodiments can be omitted.

### REFERENCE SIGNS LIST

1 Coating material
1a Metal layer
2 Base material
3 Lower coating layer
4 Upper coating layer

1. A coating material directly or indirectly provided on a surface of a base material of a fishing member and comprising a metal layer having a large number of indium particle structures containing a large number of indium flakes, wherein
a particle size of each of the indium flakes is 1 μm or less at a cumulative median value of 50%, and a particle size of the indium particle structure is in a range of 40 μm to 300 μm.

2. The coating material according to claim 1, wherein a ratio of the indium particle structure per unit area of a surface of the coating material is 25% or more, and less than 100%.

3. The coating material according to claim 1, wherein a height of the indium particle structure is in a range of 0.1 μm to 10 μm.

4. The coating material according to claim 1, wherein a lower coating layer is formed between the base material and the metal layer.

5. The coating material according to claim 1, wherein an upper coating layer is formed on a surface of the metal layer.

6. A coating method for forming a coating material, comprising: dispersing a large number of indium flakes in a solvent and spraying the dispersion by spray radiation; and drying the solvent, these steps being repeated a plurality of times to form a coating material, wherein
a particle size of each of the indium flakes is 1 μm or less at a cumulative median value of 50%, and a particle size of the indium particle structure is in a range of 40 μm to 300 μm.

7. The coating method according to claim 6, wherein the solvent is any one of a ketone-based solvent, an ether-based solvent, and an ester-based solvent, or a combination of any two or more of these solvents.

8. A fishing reel comprising a reel body and the coating material according to claim 1 formed on at least a part of a surface of the reel body.

9. A fishing rod comprising a rod body and the coating material according to claim 1 formed on at least a part of a surface of the rod body.
